(19) United States
(12) Patent Application Publication
(10) Pub. No.: US 2013/0117171 A1
(43) Pub. Date: May 9, 2013

(54) Relational Order Pricing Data for Interdependent Exchange-Traded Contracts

(71) Applicants: Ari Studnitzer, Northbrook, IL (US); Andrew P. Czupek, New Lenox, IL (US); Brian M. Wolf, Roselle, IL (US)

(72) Inventors: Ari Studnitzer, Northbrook, IL (US); Andrew P. Czupek, New Lenox, IL (US); Brian M. Wolf, Roselle, IL (US)

(73) Assignee: CHICAGO MERCANTILE EXCHANGE, INC., Chicago, IL (US)

(21) Appl. No.: 13/288,397

(22) Filed: Nov. 3, 2011

(51) Int. Cl. G06Q 40/04

(52) U.S. Cl. 705/37

(57) ABSTRACT

Prices for instances of an exchange-traded contract type can be submitted using one or more of at least two types of order pricing data. Explicit order pricing data may specify a price for one or more contracts in a first manner, e.g., by explicitly stating a specific amount of currency. Relational order pricing data may provide information that permits determination of prices for contracts based on other data.

### BACKGROUND

Participants in exchanges routinely buy, sell and otherwise deal in interdependent exchange-traded (IET) contracts. In some cases, IET contracts may be standardized according to a contract type established by an exchange. Among other things, a contract type may specify an underlying subject matter. As but one example, futures contracts are one subcategory of IET contracts. The subject matter of a futures contract may be an agricultural or other type commodity. In such a case, the contract type may further specify delivery of a predefined amount of that commodity at a predefined future date. As yet another example, the subject matter of an IET contract type may be a currency, a market index, an interest rate or other economic subject matter. In such a case, the contract type may further specify payment on a predefined date of an amount computed from the value of the contract subject matter on some future date.

There are two counterparties to an IET contract. A “long” counterparty usually refers to a counterparty holding a long position. A long counterparty agrees to pay a contract price in return for some deliverable based on the contract subject matter. That deliverable might be physical delivery of a contract commodity on a future date, payment on a future date based on a future price of the contract subject matter, etc. A “short” counterparty usually refers to a counterparty holding a short position. A short counterparty agrees to receive the contract price at the predefined future date in return for the deliverable based on the contract subject matter.

Although a long counterparty and a short counterparty correspond to every IET contract, either the long or the short counterparty of each such contract is often an exchange or clearinghouse. For example, a first counterparty may offer to sell a particular type of futures contract through an exchange. A second counterparty may bid a futures contract of that type through the exchange at same price offered by the first counterparty. After matching the offer and bid prices, the exchange establishes a first contract in which the first counterparty is short and the exchange clearinghouse is long, and an offsetting second contract in which the second counterparty is long and the exchange is short, with the contract price of the first and second contracts (the matched offer and bid prices of the counterparties) being the same. The first and second counterparties may not know each other's identities.

A given type of IET contract may have multiple possible maturity dates. For example, some futures contracts for commodity X may require delivery on date 1, others may require delivery on a later date 2, etc. Often, trading is heaviest with regard to contracts having the earliest maturity date. Those contracts are sometimes called “front month” contracts. Later-maturing contracts are sometimes called “back month” contracts. Trading of back month contracts may be substantially less heavy (or even non-existent) relative to trading of front month contracts. Back month contracts may be quoted as heavily as front month contracts, however, because the front and back month contracts are linked to the same underlying subject matter. A participant in a market for commodity X futures contracts may submit bid and/or ask prices for front month commodity X contracts at a high frequency if those front month contracts are trading at a high volume. If the back month(s) are priced so as to depend on one or more of the same fundamentals used to price the front month(s), market participants may also wish to revise bid and/or ask prices for back month commodity X futures contracts, even if those back month contracts are not trading very heavily, whenever front month contract bid and/or ask prices are revised.

Similarly, a market participant may wish to trade IET contracts having one type of subject matter based on pricing of one or more IET contracts having another subject matter. For example, a trader might wish to trade one type of currency based on prices of IET contracts having other currencies as a subject matter.

### SUMMARY

This Summary is provided to introduce a selection of concepts in a simplified form that are further described below in the Detailed Description. This Summary is not intended to identify key or essential features of the invention.

In at least some embodiments, bid and/or ask prices for one or more interdependent exchange-traded (IET) contracts can be submitted using one or more of two types of order pricing data. Explicit order pricing data may specify a price for one or more IET contracts in a first manner, e.g., by explicitly stating a specific amount of U.S. Dollars or other currency. Relational order pricing data may provide information that permits determination of bid and/or ask prices for IET contracts based on other data, e.g., prices of other IET contracts.

In at least some embodiments, explicit order pricing data may specify a price for one or more IET contracts having a first maturity date. Relational order pricing data may provide information that permits determination of prices for one or more IET contracts having a second maturity date. That determination can be based, at least in part, on prices for the one or more IET contracts having the first maturity date.

In at least some embodiments, relational order pricing data may provide information that permits determination of prices for one or more IET contracts having a first subject matter based, at least in part, on prices for one or more IET contracts having a second subject matter. That second subject matter can be different from the first subject matter.

Embodiments include methods for determining and/or storing order pricing data, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows a computer system and network in which one or more aspects of the invention may be implemented.

FIGS. 2A through 2C are block diagrams showing communications and other operations according to at least some embodiments.

FIG. 3 is a block diagram of a system, according to some embodiments, configured to perform various operations in connection with order pricing for interdependent exchange-traded contracts.

FIG. 4 is a flow chart showing operations performed by the system of FIG. 3, according to some embodiments, in connection with determining and/or storing order price data for interdependent exchange-traded contracts.

FIG. 5 is a flow chart showing operations by other modules or components of an exchange computer system, according to some embodiments, using order price data stored during one or more operations shown in FIG. 4.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, and/or any combination thereof.

Aspects of method steps described in connection with one or more embodiments may be executed on one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

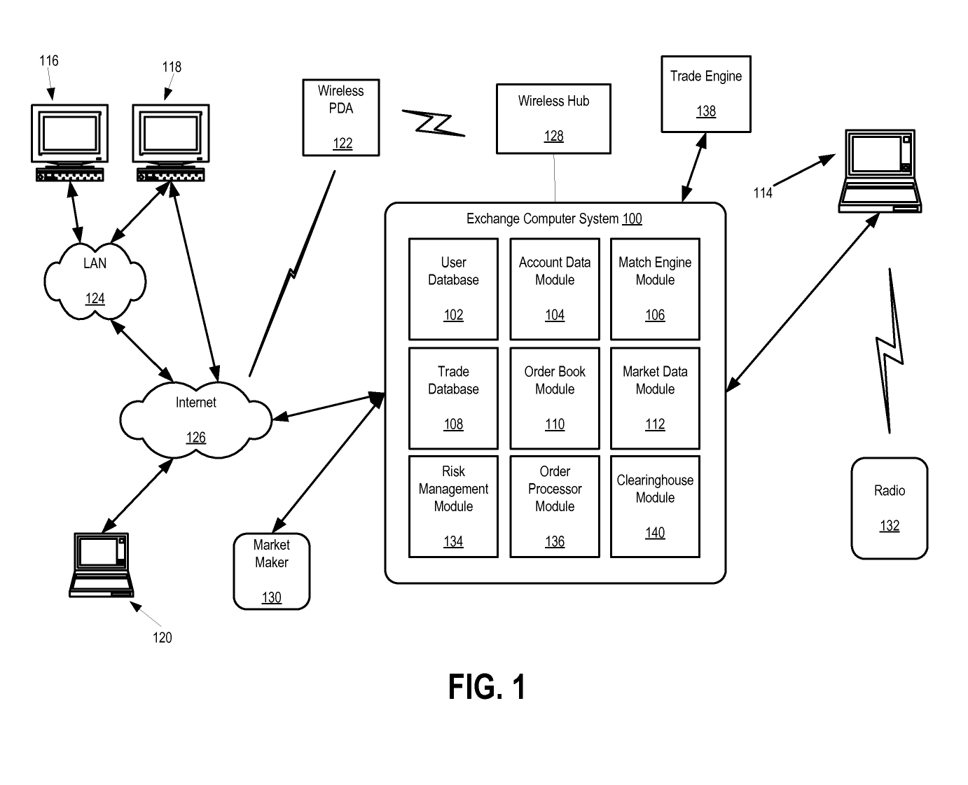

Aspects of at least some embodiments can be implemented with computer systems and computer networks that allow users to exchange trading information. An exemplary trading network environment for implementing trading systems and methods according to at least some embodiments is shown in FIG. 1. The implemented trading systems and methods can include systems and methods that determine and/or store order pricing data, such as are discussed in more detail below.

Computer system 100 can be operated by a financial exchange. Computer system 100 receives orders, transmits market data related to orders and trades to users, and performs other operations associated with a financial exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to determine and/or store current bid and offer prices. A market data module 112 may be included to collect market data, e.g., data regarding current bids and offers for futures contracts, futures contracts spread packages, options and other derivative products. Module 112 may also prepare the collected market data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

A clearinghouse module 140 may be included as part of exchange computer system 100 and configured to carry out clearinghouse operations. Module 140 may receive data from trade database 108 regarding trades of IET contracts and other financial instruments and facilitate the financial exchange acting as one of the parties to traded contracts or other instruments. For example, computer system 100 may match an ask price of party A wishing to sell a futures contract for commodity X with a bid price of party B wishing to purchase a futures contract for commodity X. Module 140 may then create a first commodity X futures contract between party A and the financial exchange and an offsetting second commodity X futures contracts between the financial exchange and party B. Module 140 may also be configured to perform other clearinghouse operations. As another example, module 140 may maintain margin accounts for member brokers. In those accounts, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on non-transitory computer-readable media. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

A market maker, broker or other participant in an exchange for interdependent exchange-traded (IET) contracts may submit order pricing data to indicate a willingness to buy and/or sell IET contracts. Order pricing data may include bid pricing data indicating the price at which an exchange participant is willing to purchase one or more contracts. Order pricing data may also (or alternatively) include ask pricing data indicating the price at which the exchange participant is willing to sell one or more contracts. IET contracts can include, without limitation, futures contracts, options contracts, over-the-counter (OTC) contracts, and other types of derivative contracts or other instruments.

In at least some embodiments, an exchange participant may communicate bid and/or ask prices for instances of a contract type having different maturity dates by submitting at least two types of order pricing data. Explicit order pricing data may specify a price for one or more contracts having a first maturity date in a first manner, e.g., by explicitly stating a specific amount of U.S. Dollars or other currency. Relational order pricing data may provide information that permits determination of bid and/or ask prices for contracts having a second maturity date. That determination may be based, at least in part, on a price for one or more first maturity date contracts.

In certain embodiments, an exchange participant may wish to price one or more IET contracts having a first subject matter based, at least in part, on prices of one or more IET contracts having one or more different subject matters. In such embodiments, relational order pricing data may provide information that permits determination of bid and/or ask prices for IET contracts having a first subject matter based (at least in part) on prices of IET contracts having second subject matter. In some cases, such relational order pricing data could provide information by which prices for first subject matter IET contracts are determined based on prices of second subject matter IET contracts and/or based on prices of IET contracts having third or additional subject matters. Embodiments in which relational order pricing data is based on contracts involving different subject matter are discussed more fully after discussion of relational order pricing data based on contracts involving different maturity dates. Of course, relational order pricing data can combine maturity-based and subject-based determinations.

With regard to futures contracts, a maturity date may be the date on which final settlements of the counterparties' obligations are due. For some types of futures contracts, this may be the date by which physical delivery of a commodity is due from the short counterparty and by which final payment is due from the long counterparty. For other types of futures contracts, the maturity date could be the date on which final cash settlement from the short counterparty is due. For options contracts, a maturity date could be the date by which the option must be exercised, and after which the option expires. These and other types of IET contracts could have maturity dates that correspond to other contractual events.

The concept of multiple maturity dates for individual instances of a common contract type can be illustrated by the following example. An exchange may define a type of futures contract. That contract type definition may specify certain contractual terms that will be the same for all instances of the contract type, i.e., for all individual contracts conforming to the contract type definition. Among other things, the type definition may specify that each individual instance requires the same type of performance at maturity, e.g., delivery of a defined amount of a single commodity. However, the type definition may not require all instances to mature at the same time. In particular, the contract type definition may allow each individual instance to specify one of several predefined maturity dates d₁ through dₙ. Dates d₁ through dₙ could be specified in the type definition as, e.g., the same day in one of several predefined months over a several year period that extends from a given date. As a more specific illustration thereof, a contract type could require that all contracts mature on the 15th of March, June, September or December, and may further allow contracts to be up to two years in duration. In this specific example, d₁ through dₙ as of January 2012 would become Mar. 15, 2012 (d₁), Jun. 15, 2012 (d₂), Sep. 15, 2012 (d₃), Dec. 15, 2012 (d₄), Mar. 15, 2013 (d₅), Jun. 15, 2013 (d₆), Sep. 15, 2013 (d₇) and Dec. 15, 2013 (d₈). As of January 2012, an exchange participant could thus buy and/or sell one or more contracts maturing on Mar. 15, 2012, could buy and/or sell one or more contracts maturing on Jun. 15, 2012, etc., up to and including buying and/or selling one or more contracts maturing on Dec. 15, 2013.

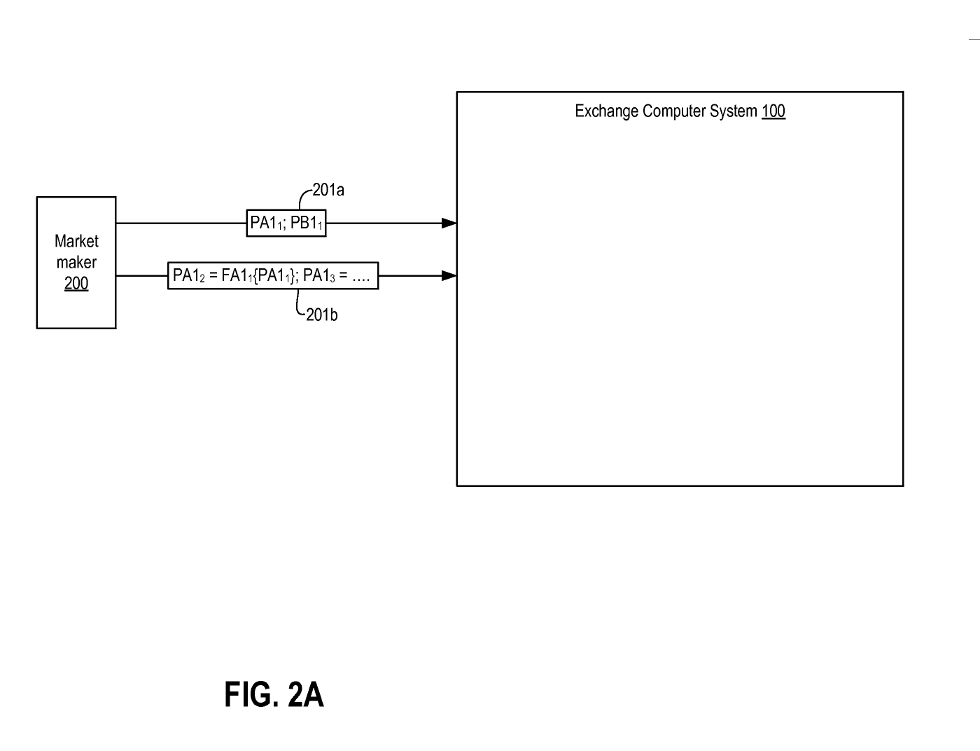

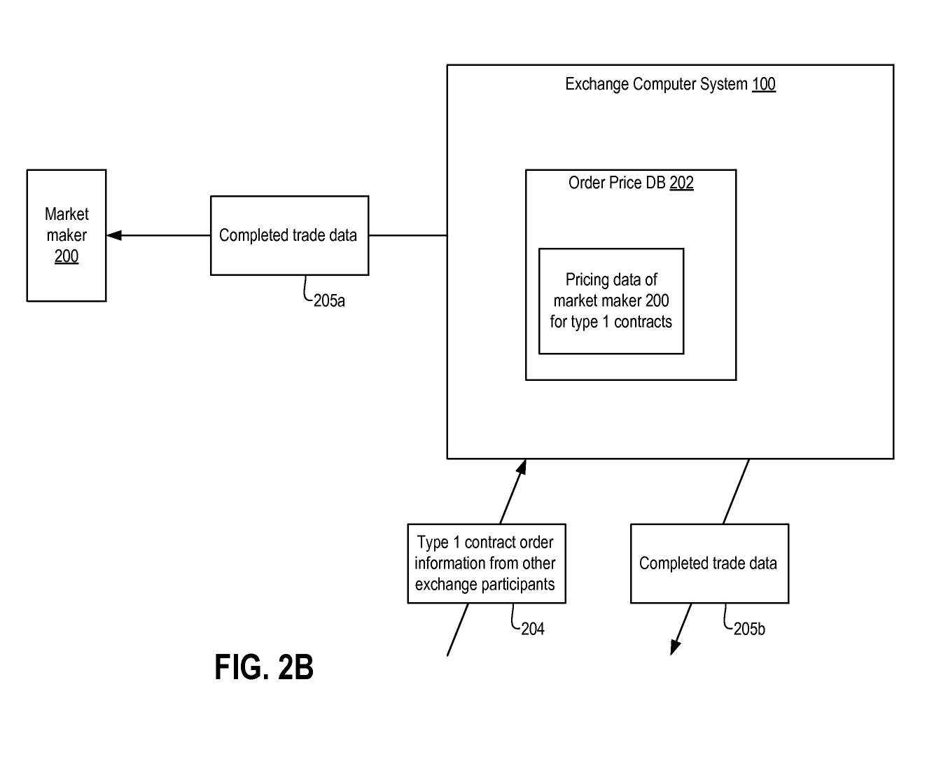

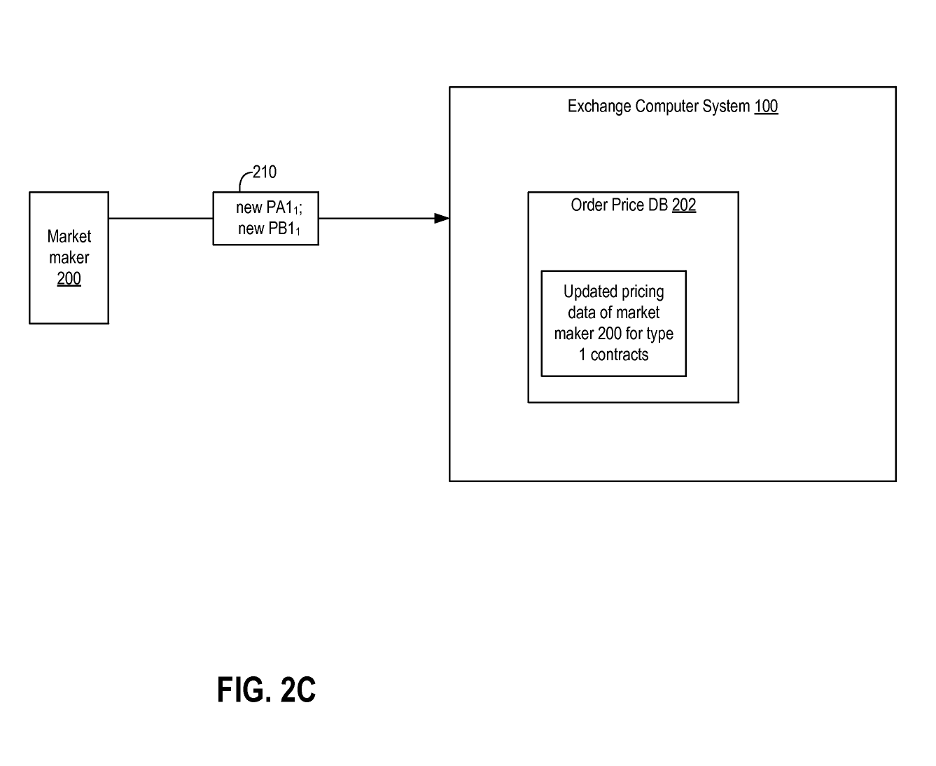

FIGS. 2A through 2C are block diagrams further illustrating some embodiments. FIGS. 2A-2C show a market maker 200 willing to buy and sell futures contracts of a predefined type. For convenience, those contracts will be referred to as “type 1” contracts in subsequent examples. The bid prices at which market maker 200 is willing to buy such contracts having various maturity dates, as well as the ask prices at which market maker 200 is willing to sell such contracts, are shown analytically in Table 1.

TABLE 1

| maturity | FA1 | FB1 | PA1 | PB1 |
|---|---|---|---|---|
| d₁ | — | — | PA1₁ | PB1₁ |
| d₂ | FA1₂ | FB1₂ | PA1₂ = | PB1₂ = |
| | | | FA1₂{PA1₁} | FB1₂{PB1₁} |
| d₃ | FA1₃ | FB1₃ | PA1₃ = | PB1₃ = |
| | | | FA1₃{PA1₁} | FB1₃{PB1₁} |
| . | . | . | . | . |
| . | . | . | . | . |
| . | . | . | . | . |
| dₙ | FAlₙ | FB1ₙ | PA1ₙ = | PB1ₙ = |
| | | | FAlₙ{PA1₁} | FB1ₙ{PB1₁} |

The first column of Table 1 (“maturity”) shows each of n possible maturity dates d₁ through dₙ allowed for type 1 contracts as of the date on which market maker 200 wishes to bid or offer such contracts. Each row of table 1 thus corresponds to type 1 contract instances maturing on the maturity date indicated in that row. The vertical dots (“ [symbol] ”) in the fourth row of Table 1 indicate an arbitrary number of additional rows, i.e., an additional row corresponding to each of an arbitrary number of maturity dates.

The second column of Table 1 (“FA1”) shows data that is used to determine ask prices for type 1 contracts maturing on different dates. For simplicity, that data is shown in Table 1 as “FA1_”, with “_” being a subscript representing a corresponding maturity date. Each FA1_ entry in Table 1 could represent an algorithm that can be used to determine a second ask price based on a first ask price. Thus, for example, the ask price for type 1 contracts maturing date “_” is determined by performing the algorithm FA1_, with an input to that algorithm being the ask price for type 1 contracts maturing on a different date. The present example assumes that the ask price (PA1₁) is explicitly provided for d₁-maturing type 1 contracts, e.g., as a specific dollar value. Accordingly, there is no FA1 entry for row 1.

The third column of Table 1 (“FB1”) shows data that is used to determine bid prices for type 1 contracts maturing on different dates. For simplicity, that data is shown in Table 1 as “FB1_”, with “_” being a subscript representing a corresponding maturity date. Each FB1_entry in Table 1 could represent an algorithm that can be used to determine a second bid price based on a first bid price. Thus, for example, the bid price for type 1 contracts maturing date “_” is determined by performing the algorithm FB1_, with an input to that algorithm being the bid price for type 1 contracts maturing on a different date. The present example assumes that the bid price (PB1₁) is explicitly provided for d₁-maturing type 1 contracts, e.g., as a specific dollar value. Accordingly, there is no FB1 entry for row 1.

Virtually any type of algorithm could be used to determine a bid (or ask) price based on another bid (or ask) price. As but one illustration thereof, a market maker might wish to bid d₂-maturing type 1 contracts according to the formula PB1₂=X1* X2*X3*PB1₁, where X1 , X2 and X3 are various factors that the market maker believes to be predictive of the amount by which the value of type 1 contract subject matter may change by maturity date d₂. The X1 factor might be a value based on one or more relevant market indices and/or historical rates of change in those indices. The X2 factor might be some value that is a function of the time until d₂. The X3 factor might be some value that accounts for previously-observed historical trends (e.g., a seasonal fluctuation in demand for a particular commodity). Innumerable other algorithms could be used. As but one further example thereof, an algorithm could comprise (or consist solely of) a lookup table that assigns prices based on some variable.

One or more of the algorithms in Table 1 could be the same. Conversely, some or all of the Table 1 algorithms could be different. Unless specifically indicated otherwise in a claim, the invention is not limited by the type of order price determination algorithm that might be used. Instead, the invention includes systems, methods and other embodiments that permit a market maker or other exchange participant to implement its proprietary algorithms in a more efficient manner.

Returning to Table 1, the fourth column (“PA1”) shows ask prices for type 1 contracts having various maturity dates. Each “PA1_” on the left side of a fourth column entry represents an ask price for contracts having the maturity date corresponding to the row in which the entry is located. In the present example, and as indicated above, market maker 200 has determined that the ask price for d₁-maturing type 1 contracts will be PA1₁, with PA1₁ being a specific dollar value. Market maker 200 has further determined that the ask prices for type 1 contracts with later maturity dates should be determined using algorithms that determine ask prices in relation to ask price PA1₁. For example, the ask price (PA1₂) for d₂-maturing type 1 contracts is determined using PA1₁ as input to algorithm FA1₂ (“FA1₂{PA1₁}”). For simplicity, the determination of a second price by an algorithm that accepts a first price as an input price is indicated by showing the algorithm as a function, and by showing the first price between braces as an argument of that function.

The fifth column (“PB1”) shows bid prices for a type 1 contracts having various maturity dates. Each “PB1_” on the left side of a fifth column entry represents a bid price for contracts having the maturity date corresponding to the row in which the entry is located. In the present example, market maker 200 has further determined that the bid price for d₁-maturing type 1 contracts will be PB1₁, with PB1₁ being a specific dollar value. PB1₁ may or may not be different from PA1₁. Market maker 200 has further determined that the bid prices for type 1 contracts with later maturity dates should be determined using algorithms that determine bid prices in relation to bid price PB1₁. For example, the bid price (PB1₂) for d₂-maturing type 1 contracts is determined using PB1₁ as input to algorithm FB1₂ (“FB1₂{PB1₁}”).

FIG. 2A shows a communication by market maker 200 with exchange computer system 100. In FIG. 2A, market maker 200 sends messages 201 to computer system 100 to provide the order pricing information of Table 1. Message 201 a includes explicit order pricing data and specifies values for PA1₁ and PB1₁. Message 201b includes relational order pricing data that provides all of the FA1 and FB1 algorithms. Relational order pricing data may explicitly define an algorithm and include all necessary information needed to carry out the algorithm once another order price has been identified as an input. Relational order pricing data might also include one or more pointers to data stored elsewhere and/or instructions to retrieve certain types of data (e.g., historical market data or other parametric data) as part of the algorithm. Although FIG. 2A shows explicit order pricing data and relational order pricing data being communicated in separate messages 201a and 201b, both types of data could be included in a single message or could be distributed among a larger number of messages.

Exchange computer system 100 subsequently uses the data transmitted by market maker 200 in FIG. 2A to determine type 1 contract order pricing for market maker 200. As shown in FIG. 2B, that pricing could be stored in an order price database 202, which database could be within (or accessible by) order book module 110 (FIG. 1). In response to incoming order communications 204 from other market participants containing bid and ask prices for type 1 contracts having various maturity dates, match engine module 106 (see FIG. 1) matches one or more of those other participants' bid and/or ask prices to ask and/or bid prices of market maker 200. After completing trades based on those matches, computer system 100 stores data to reflect those trades, e.g., in one or more databases of (or accessible by) trade engine module 108 and clearinghouse module 140. Computer system 100 might also update other data corresponding to market maker 200 based on completed trades. For example, market maker 200 may have imposed a limit on the number of type 1 contracts that market maker 200 is willing to buy or sell during a particular period. As another example, one or more of the pricing algorithms specified by market maker 200 may include a determination that is based on the recent volume of trading for a particular set of contracts. Computer system 100 also transmits information 205 to market maker 200 and to other market participants advising of the completed trades.

At a subsequent time, and as shown in FIG. 2C, market maker 200 sends one or more messages 210 to exchange computer system 100. Messages 210 contain new values for prices PA1₁ and PB1₁, but do not contain changes to the algorithms used for determining prices for type 1 contracts maturing on dates d₂ through dₙ. In response to messages 210, computer system 100 updates all the type 1 contract order pricing data of market maker 200 to include the new values of PA1₁ and PB1₁, as well as values for PA1₂-PA1ₙ and PB1₂-PB1ₙ that are re-determined based on the new values of PA1₁ and PB1₁. In response to subsequent communications from other exchange participants (similar to order communications 204 of FIG. 2B), exchange computer system 100 may perform additional matching operations relative to the updated order prices of market maker 200, execute additional trades based on that matching, and store and transmit data to reflect those trades.

At subsequent times, market maker 200 may forward additional communications to computer system 100 providing further changes to type 1 contract order pricing. Some communications may only update a value for PA1₁ and/or PB1₁. Some communications might update and/or otherwise change one or more of the algorithms used to determine bid and/or ask prices for type 1 contracts maturing on dates after d₁. Such an algorithm update may or may not retransmit all of the algorithm, e.g., only the changed portion might be transmitted in some cases. Still other communications might include an update to a PA1₁ and/or PB 1₁ value and a change to one or more of the algorithms. After each set of communications from market maker 200, computer system 100 may update the type 1 contract order pricing of market maker 100 based on the communications, may match updated order prices to order pricing of other exchange participants and execute resulting trades, and may send and store data to reflect such trades.

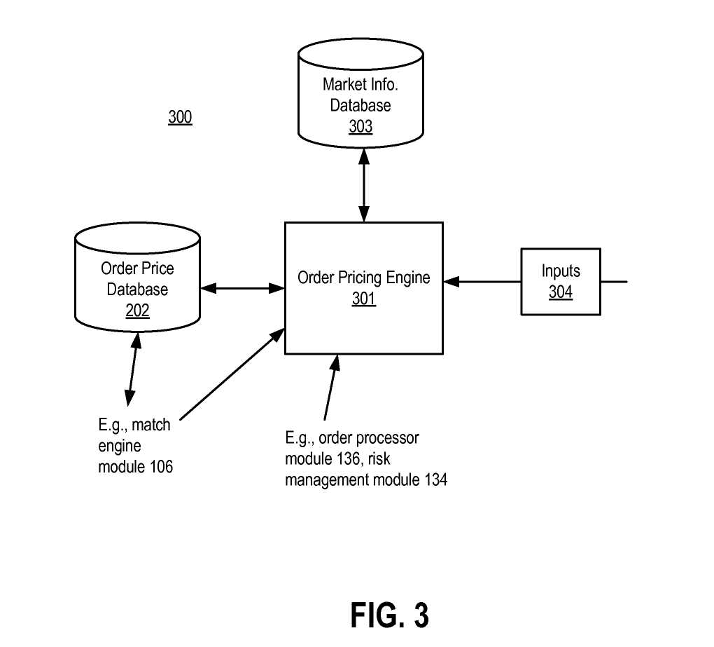

FIG. 3 is a block diagram of a system 300, according to some embodiments, that is configured to perform various operations in connection with order price determination for IET contracts. System 300 may be part of order book module 110 (FIG. 1), may be implemented as a standalone computer (or computer system), or may be implemented as part of another system.

Order pricing engine 301, which may be implemented in the form of one or more microprocessors executing program instructions, interfaces and exchanges data with and one or more order price databases 202. Database 202 maintains order pricing information for market makers and other participants in the exchange that operates computer system 100. The data stored in database 202 may include both the determined order prices for contracts maturing on different dates (e.g., PA1₁-PA1ₙ and PB1₁-PB1ₙ), as well as the algorithms and/or other relational data used to determine one or more of those order prices (e.g., FA1₂-FA1ₙ and FB1₂-FB1ₙ). The data stored in database 202 may also include order prices for IET contracts that have been determined based on prices for IET contracts having different subject matters(s). Such data could also include algorithms and/or other relational order pricing data that permits determination of one or more IET contract order prices based, at least in part, on pricing for one or more IET contracts having different subject matters. Database 202 may be implemented as a distributed database residing in one or more of the modules of exchange computer system 100 (FIG. 1), may be implemented as a one or more software routines configured to extract data from one or more of said modules, may be implemented as a standalone database accessible over the Internet or other wide area network, or may be implemented in other ways.

Order pricing engine 301 also interfaces with one or more market information databases 303. Database 303 may store any of various types of information that might be used as parametric data by an order pricing algorithm. That information could include values of the subject matters of various contract types during preceding periods, values for various market indices (e.g., the Standard and Poor's 500, the Dow Jones Industrial Average) at previous times, information regarding values for specific stocks, commodities, and other subject matters at previous times, data regarding recent trades in various futures contracts, published interest rates, etc. Database 303 could be a part of exchange computer system 100 and/or could comprise links to one or more external databases and/or market information services.

Data feeds from databases 202 and/or 303 could be pulled by engine 301, e.g., received in response to requests by engine 301 for updated data or in response to some other inquiry by engine 301. Data feeds from databases 202 and/or 303 could also be pushed to engine 301. For example, database 202 and/or 303 could be configured to periodically transmit updates to engine 301 containing changed order pricing and/or market data. In response to such pushed data feeds, and as discussed more fully below, engine 301 could revise order prices that would be altered by the pushed data.

Engine 301 may receive various inputs 304 as a result of communications from exchange participants, e.g., as a result of communications such as communications from market maker 200 described in connection with FIGS. 2A-2C. Inputs 304 may include explicit order pricing data (e.g., values such as values for PA1₁ and PB1₁). Inputs 304 may also include relational order pricing data that is used to determine a second order price based on a first order price. Such data could include data defining and/or modifying algorithms such as algorithms FA1₂-FA1ₙ and FB1₂-FB1ₙ.

In response to inputs 304, engine 301 stores and/or updates order pricing data in database 202. That order pricing data may then be accessed by match engine module 106 and/or other modules of computer system 100. Engine 301 might also receive inputs from other modules of computer system 100. For example, executed trades could be reported to engine 301 from order processor module 136 and/or from risk management module 134. If an exchange participant defined an order pricing algorithm to determine a price based on that participant's recent trades and/or on that participant' total position in contracts maturing on a particular date, a report of executed trades could cause engine 301 to update that participant's order pricing data in database 202.

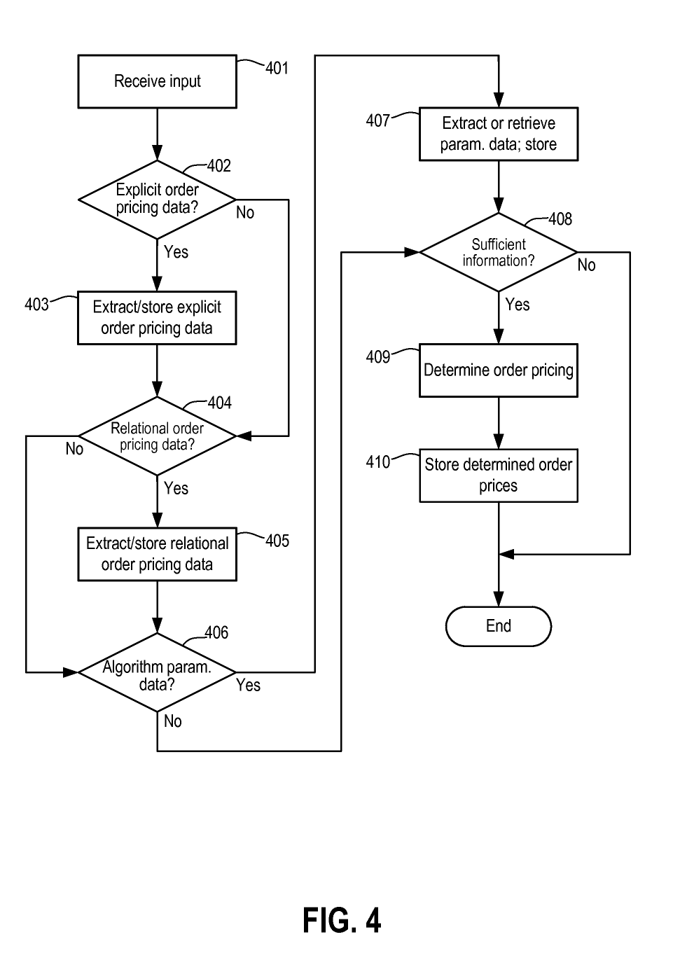

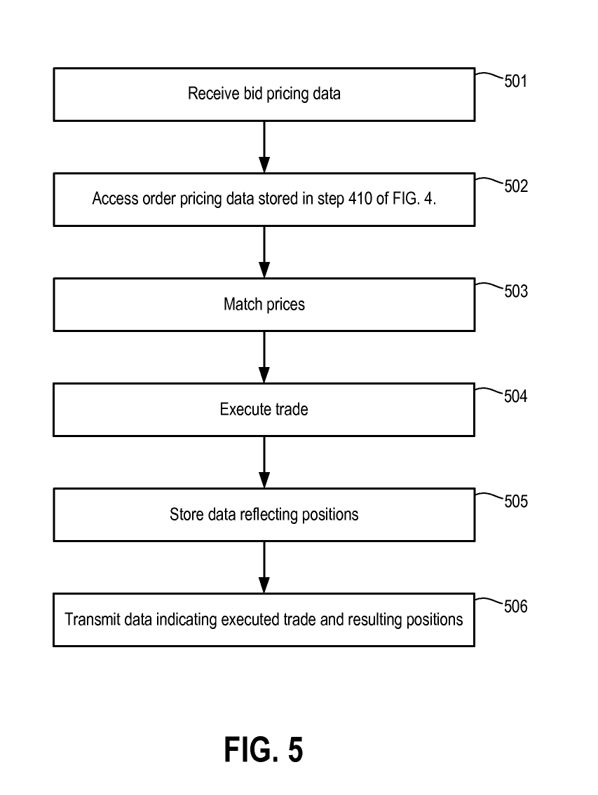

FIG. 4 is a flow chart showing operations performed by system 300, according to some embodiments, in connection with determining and/or updating order prices for IET contracts. As will become clear in view of the following discussion, system 300 may recursively perform the operations of FIG. 4 for a single contract type in which a single exchange participant may wish to trade. In further discussions of FIGS. 4 and 5, “the subject exchange participant” and “the subject contract type” respectively refer to that single exchange participant and that single contract type. The operations of FIG. 4 could be separately performed (e.g., in separate programming threads) for each of the other contract types in which the subject exchange participant may wish to trade, as well as for each contract type in which other market participants may wish to trade. For example, engine 301 may repeatedly perform the operations of FIG. 4 in one programming thread for a first exchange participant and a first contract type, may repeatedly perform the operations of FIG. 4 in another programming thread for the first exchange participant and a second contract type, may repeatedly perform the operations of FIG. 4 in yet another programming thread for a second exchange participant and a third contract type, etc.

In step 401, engine 301 receives data that includes one or more of at least three types of data. The data received in step 401 could be (or could include) explicit order pricing data provided to engine 301 in an input 304. Explicit order pricing data specifies a price for a group of instances of the subject contract type. In some embodiments, that group may be instances of the subject contract type having a particular maturity date. Examples of explicit order pricing data could include dollar values for PA1₁ and PB1₁ such as previously discussed.

The data received in step 401 could be (or could include) relational order pricing data provided to engine 301 in an input 304. Relational order pricing data may permit determination of an order price for instances of the subject contract type based, at least in part, on prices of one or more other instances of IET contracts. In some embodiments, that relational order pricing data may permit determination of order prices for instances of the subject contract type having a second maturity date based on a price for instances of the subject contract type having a first maturity date. Examples of such relational order pricing data include algorithms FA1₂-FA1ₙ and FB1₂-FB1ₙ such as previously discussed, as well as portions of those algorithms (e.g., constants, subroutines, pointers to values in other databases, etc.) that might be received as an update to a previously stored algorithm. In some embodiments, and as discussed more fully below, relational order pricing data may include one or more algorithms or algorithm portions that permit determination of IET contract instance pricing based at least in part on pricing of instances of a different type of contract. That different type of contract may have a subject matter that is different from that of the subject contract type.

The data received in step 401 could be (or could include) algorithm parametric data that is used by a relational order pricing algorithm when determining an order price. In some cases, algorithm parametric data may include a value of a published market index or other economic indicator. In some cases, parametric data could include recent trade prices for instances of other contract types. The data received in step 401 could also be a signal to retrieve updated parametric data from database 202, database 303 and/or some other source. Such a signal could be generated by a separate timer program of engine 301 that issues such a signal at certain intervals. Such a signal could also be a communication from an outside source indicating that updated parametric information is available.

In step 402, engine 301 determines if the received data includes explicit order pricing data. If not, engine 301 continues directly to step 404 on the “no” branch. If the received data does include explicit order pricing data, engine 301 continues to step 403 on the “yes” branch. In step 403, engine 301 extracts the explicit order pricing data and stores that data in database 202 in one or more storage locations associated with the subject exchange participant and the subject contract type. Data stored during step 403 could include one or more initial values. For example, the subject exchange participant may not have previously traded instances of the subject contract type. Data stored during step 403 could also (or alternatively) include an update to a previously stored value.

In step 404, engine 301 determines if the received data includes relational order pricing data. If not, engine 301 continues directly to step 406 on the “no” branch. If the received data does include relational order pricing data, engine 301 continues to step 405 on the “yes” branch. In step 405, engine 301 extracts the relational order pricing data and stores that data in database 202 in one or more storage locations associated with the subject exchange participant and the subject contract type. Data stored during step 405 could include initial algorithm data received by computer system 100 in connection with order pricing of the subject contract type for the subject exchange participant. Data stored during step 405 could also (or alternatively) include an update to a previously stored algorithm.

In step 406, engine 301 determines if the received data include algorithm parametric data and/or a signal to retrieve updated algorithm parametric data. If not, engine 301 continues directly to step 408 on the “no” branch. If the received data does include parametric data and/or a signal to retrieve updated algorithm data, engine 301 continues to step 407 on the “yes” branch. In step 407, engine 301 extracts the parametric data (if present) and/or retrieves parametric data (if a signal to do so is present). As indicated above, an order pricing algorithm could include determinations based on one or more types of parametric data. Such parametric data could include values for variables such as various market indices, historical values of contract subject matter, interest rates, etc. The parametric data is then stored in database 202 in one or more storage locations associated with the subject exchange participant and the subject contract type.

In step 408, engine 301 determines if there is sufficient information to determine order pricing for the subject contract type. For example, as part of setting up its account, the subject exchange participant may initially provide explicit order pricing data in a first communication, relational order pricing data in a second communication, and parametric data in a third communication. If engine 301 reaches step 408 after the first communication and before the second communication, there may be insufficient data stored at that point to determine order pricing for the subject contract type. In such a case, engine 301 would then end the sequence of FIG. 4 by proceeding to the End block on the “no” branch from step 408. The sequence of FIG. 4 would then restart at step 401 when the second communication is received. A similar series of steps might occur if block 408 is reached after the second communication and before the third communication.

If engine 301 determines in step 408 that there is sufficient information to determine order pricing, engine 301 proceeds to step 409 on the “yes” branch. In step 409, engine 301 performs the algorithms stored for the subject exchange participant and the subject contract type. In some embodiments, engine 301 may perform all of the algorithms associated with the subject exchange participant and the subject contract type, without regard to whether this might be necessary. For example, the subject exchange participant could be market maker 200 and the subject contract type could be type 1. Moreover, the data received in step 401 may only have updated PA1₁ and/or one or more of FA1₂-FA1ₙ. Even though prices PB1₂-PB1ₙ would be unaffected by such updates, engine 301 might perform each of algorithms FA1₂-FA1ₙ and FB1₂-FB1ₙ. In other embodiments, engine 301 might make an initial determination as to which order prices might be affected by any updates, and only perform algorithms associated with prices that might be affected.

In step 410, engine 301 stores determined (or re-determined) order prices of the subject exchange participant for the subject contract type. This order price data, which engine 301 stores in database 202 in one or more storage locations associated with the subject exchange participant and the subject contract type, can then be accessed by match engine module 106 and/or other modules of exchange computer system 100. After step 410, the sequence shown in FIG. 4 ends. A new iteration of the sequence may start in response to receipt of new inputs 304 containing updated explicit and/or relational order pricing data. A new iteration of the sequence may also begin in response to updated parametric data and/or signals indicating that updated parametric data should be retrieved. A new iteration might also begin in response to another type of input, e.g., an input indicating that the subject exchange participant has reached a limit with regard to that participant's position as to contract instances having a particular maturity date.

FIG. 5 is a flow chart showing exemplary operations performed by other modules or components of computer system 300, according to some embodiments, using the order pricing data stored during step 410 of FIG. 4. In step 501, computer system 100 receives bid pricing data, for N instances of the subject contract type, from another exchange participant. As but one example, that other exchange participant may have submitted a bid for 20 instances of the subject contract type having a specified maturity date. In step 502, computer system 100 accesses order price data stored in database 202 for the subject exchange participant and the subject contract type. In step 503, computer system 100 matches the ask price of the subject exchange participant for N instances of the subject contract type (e.g., 20 instances having the specified maturity date) with the bid pricing data received in step 501. In step 504, computer system 100 executes a trade for N instances of the subject contract type. In step 505, computer system 100 stores data reflecting a short position of the subject exchange participant in N instances of the subject contract type, as well as data reflecting a long position of the other exchange participant in N instances of the subject contract type. In step 506, computer system 100 transmits data to the subject exchange participant and the other exchange participant indicating the executed trade and their respective short and long positions.

FIG. 5 is only one illustration of operations that could be performed using the order pricing data stored during step 410 of FIG. 4. For example, similar operations could be performed if the other exchange participant had submitted an ask price.

Other embodiments include numerous variations on the systems and methods described above. Although the examples thus far have assumed that order prices for later maturing contracts are determined based on order prices of earlier maturing contracts, this is not a requirement. In some embodiments, a price could be explicitly specified for instances of a contract maturing on date dₙ, with prices for instances with an earlier maturity date dₙ₋₁ being determined by an algorithm that accepts the price for dₙ-maturing instances as an input (e.g., PA1ₙ₋₁=FA1ₙ₋₁{PA1ₙ} and/or PB1ₙ₋₁=FB1ₙ₋₁{PB1ₙ}). In some cases, an algorithm could be extremely simple. For an example, an algorithm could be a simple “peg” that sets one price equal to another price (e.g., PA1ₙ=FA1ₙ{PAₙ₋₁}=PA1ₙ₋₁ and/or PB1ₙ=FB1ₙ{PB1ₙ₋₁}=PB1ₙ₋₁). As another example, an algorithm could be a simple multiplication by a single constant (e.g., PA1ₙ=FA1ₙ{PA1ₙ₋₁}=1.025*PA1ₙ₋₁ and/or PB1ₙ=FB1ₙ{PB1ₙ₋₁}=1.025*PB1ₙ₋₁), a simple division, the simple addition of a single term (e.g., PA1ₙ=FA1ₙ{PA1ₙ₋₁}=PA1₁₋ₙ+10 and/or PB1ₙ=FB1ₙ{PB1ₙ₋₁}=PB1ₙ₋₁−10), etc.

A market maker or other exchange participant could define its order pricing to include more or less than two explicitly specified price values. As one example thereof, market maker 200 could define its ask price for dᵢ-maturing type 1 contracts by defining an algorithm FA1₁ that determines PA1₁ based on an explicitly defined PB1₁ (e.g., PA1₁=FA1₁{PB1₁}). As another example, market maker 200 could have explicitly specified one or more of PA1₂-PA1ₙ in addition to explicitly specifying PA1₁ and/or explicitly specified one or more of PB1₂-PB1ₙ in addition to explicitly specifying PB1₁.

The input to a price determination algorithm could be a price that was determined by another algorithm. As one example thereof, market maker could have defined PA1₂=FA1₂{PA1₁} and defined PA1₃=FA1₃{PA1₂}. In this manner, order prices can be “laddered” on one another.

In some embodiments, and as indicated above, relational order pricing data may permit determination of order pricing for instances of a contract type having one subject matter based (at least in part) on instances of a different contract type having a different subject matter. As but one illustration thereof, an exchange participant might wish to submit bid and ask prices for instances type 2 contracts as shown analytically in Table 2.

TABLE 2

| maturity | FA2 | FB2 | PA2 | PB2 |
|---|---|---|---|---|
| d₁ | FA2₁ | FB2₁ | PA2₁ = | PB2₁ = |
| | | | FA2₁{PA3₁} | FB2₁{PB3₁} |
| d₂ | FA2₂ | FB2₂ | PA2₂ = | PB2₂ = |
| | | | FA2₂{PA2₁} | FB2₂{PB2₁} |
| d₃ | FA2₃ | FB2₃ | PA2₃ = | PB2₃ = |
| | | | FA2₃{PA2₂} | FB2₃{PB2₂} |
| . | . | . | . | . |
| . | . | . | . | . |
| . | . | . | . | . |
| dₙ | FA2ₙ | FB2ₙ | PA2ₙ = | PB2ₙ = |
| | | | FA2ₙ{PA2ₙ₋₁} | FB2ₙ{PB2ₙ₋₁} |

The example of Table 2 assumes that type 2 contracts have a first subject matter (e.g., a first currency). Similar to the example of Table 1, the first column of Table 2 (“maturity”) shows each of n possible maturity dates d₁ through dₙ allowed for type 2 contracts as of the date on which the exchange participant wishes to bid or offer such contracts. Each “FA2_” entry in the second column represents an algorithm that can be used to determine an ask price for type 2 contracts maturing on date “_”. Each “FB2_” entry in the third column represents an algorithm that can be used to determine a bid price for type 2 contracts maturing on date “_”. Each entry in the fourth column shows ask prices for type 2 contracts having the maturity date corresponding to the row in which the entry is located. That ask price is represented as “PA2_”, which is equal to the output of a corresponding algorithm (“FA2_”). The input to the algorithm to obtain the ask price PA2_{—} is shown between braces (“{}”). Each entry in the fifth column shows bid prices for type 2 contracts having the maturity date corresponding to the row in which the entry is located. That bid price is represented as “PB2_”, which is equal to the output of a corresponding algorithm (“FB2_”). The input to the algorithm to obtain the bid price PB2 is shown between braces (“{}”).

In a series of communications similar to those shown in FIG. 2A, the exchange participant might initially provide exchange computer system 100 with relational order pricing data FA2₁ through FA2ₙ, relational order pricing data FB2₁ through FB2ₙ, explicit order pricing data specifying a value for PA3₁ and explicit order pricing data specifying a value for PB3₁. Exchange computer system 100 could then determine the exchange participant's type 2 contract order pricing, match that pricing against other participants' order pricing, and complete trades based on the matching, similar to the operations shown in FIG. 2B. The exchange participant might then provide explicit order pricing data specifying updated values for PA3₁ and/or PB3₁, in response to which computer system 100 might determine updated order pricing for type 2 contracts, similar to the operations shown in FIG. 2C.

As seen in Table 2, the input to the algorithm FA2₁ used to obtain the type 2 contract ask price for d₁-maturing contracts (PA2₁) is the exchange participant's ask price PA3₁ for a type 3 contract maturing on date d₁. Similarly, the input to the algorithm FB2₁ used to obtain the type 2 contract bid price for d₁-maturing contracts (PB2₁) is the exchange participant's bid price PB3₁ for a type 3 contract maturing on date d₁. Type 3 contracts have a subject matter that is different from the subject matter of type 2 contracts. If the subject matter of type 2 contracts is a first currency, for example, the subject matter of a type 2 contract might be a second currency that is different from a first currency. As a more specific example, type 2 contracts might be Euro/U.S. Dollar contracts and type 3 contracts might be Euro/Yen contracts. Numerous other types of dissimilar contracts could be related in an exchange participant's order pricing algorithm. As but another example, type 2 contracts might be oil futures contracts and type 3 contracts might be gold futures contracts (or vice versa).

As with the example of Table 1, the algorithms FA2₁-FA2ₙ and FB2₁-FB2ₙ of the Table 2 example could all be different. Alternatively, one or more of those algorithms might be the same. Any of the algorithms could be extremely complex or extremely simple. For example, an algorithm could include a simple division of one currency value by another currency value.

In the example of Table 2, each of the ask prices for maturities d₂ through dₙ is laddered on the preceding maturity date ask price. For example, the input to the algorithm FA2₂ is the ask price PA2₁ for d₁-maturing contracts. Similarly, each of the bid prices for maturities d₂ through dₙ is laddered on the preceding maturity date bid price. This need not be the case. For example, one or more of d₂ through dₙ algorithms could accept a type 3 contract price as an input (e.g., PA2ₙ=FA2ₙ{PA3ₙ}).

In other embodiments, order pricing algorithms may receive prices for multiple other types of contracts as an input. As but one example, an ask price order pricing algorithm FA4ₙ for type 4 contract instances maturing on date dₙ could receive as inputs ask prices for type 5, type 6 and/or additional types of contracts (e.g., PA4ₙ=FA4ₙ{PA5ₙ, PA6ₙ}). In still other embodiments, an order pricing algorithm could receive as inputs prices for contracts of the same type maturing on different dates and prices for contracts of different types (e.g., PB7ₙ=FB7ₙ{PB7₁, PB8ₙ}).

In some embodiments, relational order pricing data may not require order pricing of another contract instance as an input. As but one example, a relational order pricing algorithm could determine a bid (or ask) price based solely on a published stock index, a published interest rate, a currency exchange rate, and/or other types of parametric data.

System 300 described in connection with FIG. 3 could be embedded in modules of exchange computer system 100 other than order book module 110. For example, system 300 could be included as part of match engine module 106.

At least some examples thus far have assumed that maturity dates are separated by one or more months. This is also not a requirement. In some embodiments, some instances of a contract type might mature within weeks, days or even hours of another instance. Accordingly, and as used herein (including the claims), a “maturity time” could be a date (i.e., a specific day of a specific month of a specific year) or could be a date and time (i.e., a specific time on a specific day of a specific month of a specific year). A “maturity time” could also be a time period. As but one example thereof, a contract type definition might require that a contract be completed during a three-day period commencing on a specific date.

Embodiments include methods, systems and other implementations that determine and/or store order pricing data for numerous types of IET contracts. Without limitation, such contract types include agricultural commodities futures contracts and futures option contracts, energy commodities futures contracts and futures option contracts, equity index futures contracts and futures option contracts, currency exchange futures contracts and futures option contracts, interest rate swaps, metal commodities futures contracts and futures option contracts, and other derivative contracts.

Various advantages are offered by one or more embodiments. For example, use of explicit and relational order pricing data allows reduced communications between an exchange participant and an exchange. As another example, order slippage for later-maturing contracts can also be reduced.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that the steps illustrated in the illustrative figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving, at a computer system, order pricing data for instances of an exchange-traded contract type, wherein
the order pricing data includes relational order pricing data for instances of the contract type, and
the relational order pricing data includes data for determining a price for the instances of the contract type based on other data;
determining the price for instances of the contract type at the computer system and based at least in part on the relational order pricing data and the other data; and
storing the determined price at the computer system.

2. The method of claim 1, wherein
the order pricing data includes explicit order pricing data specifying a first price for individual instances of the contract type having a first maturity time,
the relational order pricing data includes data for determining a second price, based on the first price, for individual instances of the contract type having a second maturity time,
determining the price includes determining the second price based at least in part on the relational order pricing data and the first price, and
storing the determined price includes storing the first and second prices.

3. The method of claim 2, wherein the first maturity time precedes the second maturity time.

4. The method of claim 2, wherein the relational order pricing data comprises data defining at least a portion of an algorithm.

5. The method of claim 2, wherein the explicit order pricing data and the relational order pricing data are received in the same communication.

6. The method of claim 2, further comprising receiving update data at the computer system, the update data including a modification to one of the explicit order pricing data and relational order pricing data but not including a modification to the other of the explicit order pricing data and the relational order pricing data.

7. The method of claim 2, wherein
the received order pricing data includes order pricing data for instances of the contract type having a third maturity time,
the first, second and third maturity times are different from one another, and
the order pricing data for instances of the contract type having the third maturity time includes additional relational order pricing data for determining a third price based on the first price, the additional relational order pricing data being different from the relational order pricing data, and further comprising
storing the third price at the computer system.

8. The method of claim 2, wherein
the explicit order pricing data comprises a bid price for instances of the contract type having the first maturity time and a separate ask price for instances of the contract type having the first maturity time,
the relational order pricing data specifies an algorithm for determining a bid price for instances of the contract type having the second maturity time based on the bid price for instances of the contract type having the first maturity time, and
the relational order pricing data specifies an algorithm for determining an ask price for instances of the contract type having the second maturity time based on the ask price for instances of the contract type having the first maturity time.

9. The method of claim 2, further comprising receiving additional data from a source other than the source of the order pricing data, and wherein determining the second price comprises determining the second price based at least in part on the relational order pricing data, the first price and the received additional data.

10. The method of claim 1, wherein the contract type is selected from the following: an agricultural commodities futures contract type, an agricultural commodities futures option contract type, an energy commodities futures contract type, an energy commodities futures option contract type, an equity index futures contract type, an equity index futures option contract type, a currency exchange futures contract type, a currency exchange futures option contract type, an interest rate swap contract type, a metal commodities futures contract type, and a metal commodities futures contract option type.

11. The method of claim 1, wherein
the order pricing data includes explicit order pricing data specifying a first price for individual instances of a first contract type, the first contract type having a first subject matter,
the relational order pricing data includes data for determining a second price, for individual instances of the contract type, based on the first price,
the contract type has a second subject matter different from the first subject matter,
determining the price includes determining the second price based at least in part on the relational order pricing data and the first price, and
storing the determined price includes storing the first and second prices.

12. One or more non-transitory computer-readable media storing computer executable instructions that, when executed, cause a computer system to perform operations that include:
receiving order pricing data for instances of an exchange-traded contract type, wherein
the order pricing data includes relational order pricing data for instances of the contract type, and
the relational order pricing data includes data for determining a price for the instances of the contract type based on other data;
determining the price for the instances of the contract type based at least in part on the relational order pricing data and the other data; and
storing the determined price.

13. The one or more non-transitory computer-readable media of claim 12, wherein
the order pricing data includes explicit order pricing data specifying a first price for individual instances of the contract type having a first maturity time,
the relational order pricing data includes data for determining a second price, based on the first price, for individual instances of the contract type having a second maturity time,
determining the price includes determining the second price based at least in part on the relational order pricing data and the first price, and
storing the determined price includes storing the first and second prices.

14. The one or more non-transitory computer-readable media of claim 13, wherein the first maturity time precedes the second maturity time.

15. The one or more non-transitory computer-readable media of claim 13, wherein the relational order pricing data comprises data defining at least a portion of an algorithm.

16. The one or more non-transitory computer-readable media of claim 13, wherein the stored instructions further comprise instructions that, when executed, cause the computer system to perform operations that include receiving update data, the update data including a modification to one of the explicit order pricing data and relational order pricing data but not including a modification to the other of the explicit order pricing data and the relational order pricing data.

17. The one or more non-transitory computer-readable media of claim 13, wherein
the received order pricing data includes order pricing data for instances of the contract type having a third maturity time,
the first, second and third maturity times are different from one another,
the order pricing data for instances of the contract type having the third maturity time includes additional relational order pricing data for determining a third price based on the first price, the additional relational order pricing data being different from the relational order pricing data, and
the stored instructions further comprise instructions that, when executed, cause the computer system to perform operations that include storing the third price.

18. The one or more non-transitory computer-readable media of claim 13, wherein the stored instructions further comprise instructions that, when executed, cause the computer system to perform operations that include receiving additional data from a source other than the source of the order pricing data, and wherein determining the second price comprises determining the second price based at least in part on the relational order pricing data, the first price and the received additional data.

19. The one or more non-transitory computer-readable media of claim 12, wherein
the order pricing data includes explicit order pricing data specifying a first price for individual instances of a first contract type, the first contract type having a first subject matter,
the relational order pricing data includes data for determining a second price, for individual instances of the contract type, based on the first price,
the contract type has a second subject matter different from the first subject matter,
determining the price includes determining the second price based at least in part on the relational order pricing data and the first price, and
storing the determined price includes storing the first and second prices.

20. A computer system comprising:
at least one processor; and
at least one non-transitory memory, wherein the at least one non-transitory memory stores instructions that, when executed, cause the computer system to perform operations that include
receiving order pricing data for instances of an exchange-traded contract type, wherein
the order pricing data includes relational order pricing data for instances of the contract type, and
the relational order pricing data includes data for determining a price for the instances of the contract type based on other data,
determining the price for the instances of the contract type based at least in part on the relational order pricing data and the other data, and
storing the determined price.

21. The computer system of claim 20, wherein
the order pricing data includes explicit order pricing data specifying a first price for individual instances of the contract type having a first maturity time,
the relational order pricing data includes data for determining a second price, based on the first price, for individual instances of the contract type having a second maturity time,
determining the price includes determining the second price based at least in part on the relational order pricing data and the first price, and
storing the determined price includes storing the first and second prices.

22. The computer system of claim 21, wherein the first maturity time precedes the second maturity time.

23. The computer system of claim 21, wherein the relational order pricing data comprises data defining at least a portion of an algorithm.

24. The computer system of claim 21, wherein
the at least one non-transitory memory stores instructions that, when executed, cause the computer system to perform operations that include receiving update data, the update data including a modification to one of the explicit order pricing data and relational order pricing data but not including a modification to the other of the explicit order pricing data and the relational order pricing data.

25. The computer system of claim 21, wherein
the received order pricing data includes order pricing data for instances of the contract type having a third maturity time,
the first, second and third maturity times are different from one another,
the order pricing data for instances of the contract type having the third maturity time includes additional relational order pricing data for determining a third price based on the first price, the additional relational order pricing data being different from the relational order pricing data, and
the at least one non-transitory memory stores instructions that, when executed, cause the computer system to perform operations that include storing the third price.

26. The computer system of claim 21, wherein the at least one non-transitory memory stores instructions that, when executed, cause the computer system to perform operations that include receiving additional data from a source other than the source of the order pricing data, and wherein determining the second price comprises determining the second price based at least in part on the relational order pricing data, the first price and the received additional data.

27. The computer system of claim 20, wherein
the order pricing data includes explicit order pricing data specifying a first price for individual instances of a first contract type, the first contract type having a first subject matter,
the relational order pricing data includes data for determining a second price, for individual instances of the contract type, based on the first price,
the contract type has a second subject matter different from the first subject matter,
determining the price includes determining the second price based at least in part on the relational order pricing data and the first price, and
storing the determined price includes storing the first and second prices.
